(19) United States
(12) Patent Application Publication
(10) Pub. No.: US 2012/0235991 A1
(43) Pub. Date: Sep. 20, 2012

(54) THREE DIMENSIONAL DISPLAY AND DRIVING METHOD THEREOF

(75) Inventor: Kuo-Chung Huang, Taipei City (TW)

(73) Assignee: INDUSTRIAL TECHNOLOGY RESEARCH INSTITUTE, Hsinchu (TW)

(21) Appl. No.: 13/413,662

(22) Filed: Mar. 7, 2012

Related U.S. Application Data
(60) Provisional application No. 61/452,653, filed on Mar. 15, 2011.

(30) Foreign Application Priority Data
Sep. 15, 2011 (TW) 100133229

(51) Int. Cl. G09G 5/10; G06T 15/00

(52) U.S. Cl. 345/419; 345/690

(57) ABSTRACT

A stereo display including a display panel unit, a phase modulator unit, a backlight unit and a control unit is described. The display panel unit sequentially displays a right eye image and a left eye image according to an image synchronizing control signal. The phase modulator unit is disposed at one side of the display panel unit and is sequentially switched to be a right eye phase and a left eye phase. The backlight unit is disposed at the other side of the display panel unit and is turned on and turned off repeatedly. The control unit is electrically connected to the display panel, the phase modulator unit and the backlight unit and controls the phase modulator unit and the back light unit according to the image synchronizing control signal.

### CROSS-REFERENCE TO RELATED APPLICATION

This application claims the priority benefits of U.S.A. provisional application Ser. No. 61/452,653, filed on Mar. 15, 2011 and Taiwan application serial no. 100133229, filed on Sep. 15, 2011. The entirety of each of the above-mentioned patent applications is hereby incorporated by reference herein and made a part of this specification.

### BACKGROUND OF THE DISCLOSURE

1. Field of the Disclosure

The disclosure relates to a three-dimensional (3D) display and a driving method thereof Particularly, the disclosure relates to a 3D display of using a polarizing glasses and a driving method thereof

2. Description of Related Art

According to existing display techniques, three-dimensional (3D) displays are generally divided into stereoscopic displays that require a user to wear a pair of specially designed glasses and auto-stereoscopic displays that can be viewed through naked eyes. Regarding the auto-stereoscopic display, a plurality of images from different viewing angles are respectively sent to a left eye and a right eye of the user, and 3D images are produced without assisting of the specially designed glasses. The images of a plurality of different viewing angles are displayed along a horizontal direction. However, a problem of the auto-stereoscopic display is that once the eyes of the user deviate from specified positions, the 3D display effect disappears.

The stereoscopic displays include shutter glasses 3D displays and micro phase difference passive glasses type 3D displays.

An operation principle of the shutter glasses 3D display is that when the 3D display plays images, the images are divided into right eye images and left eye images. When the right eye image is played for the right eye, the shutter glasses is used to shield the left eye image, so that only the right eye can view the displayed image. Then, the left eye image is played, and the shutter glasses is used to shield the right eye image, so that only the left eye can view the displayed image. By alternately displaying the left eye and right eye images, the user can view 3D images. However, when such 3D display applies a liquid crystal display (LCD) panel to serve as a display screen, since the 3D display is required to be synchronized with the shutter glasses, a problem of poor display quality is occurred, or the user may have an uncomfortable feeling when viewing the 3D images, which is because that a response speed of the LCD panel is not fast enough.

An operation principle of the micro phase difference passive glasses type 3D display is to control a half of pixels of the LCD panel to display the right eye image and another half of the pixels to display the left eye image, where the right eye image and the left eye image can respectively pass through a right lens and a left lens of a pair of polarizing glasses. Although the micro phase difference passive glasses type 3D display does not have the problem of the above shutter glasses 3D display that the user may have an uncomfortable feeling when viewing the 3D images, the micro phase difference passive glasses type 3D display has a problem that a resolution of the displayed 3D image is reduced by a half compared to that of the aforementioned 3D display, which causes a poor 3D image quality.

### SUMMARY OF THE DISCLOSURE

The disclosure provides a three-dimensional (3D) display including a display panel unit, a phase modulator unit, a backlight unit and a control unit. The display panel unit sequentially displays a right eye image and a left eye image according to an image synchronizing control signal. The phase modulator unit is disposed at one side of the display panel unit and is sequentially switched to be a right eye phase and a left eye phase. The backlight unit is disposed at the other side of the display panel unit and is turned on and turned off repeatedly. The control unit is electrically connected to the display panel unit, the phase modulator unit and the backlight unit and controls the phase modulator unit to sequentially switch to be the right eye phase and the left eye phase, and controls the backlight unit to turn on and turn off.

The disclosure provides a driving method of a three-dimensional (3D) display, which includes following steps. The 3D display including a display panel unit, a phase modulator unit, a backlight unit and a control unit is provided. The display panel unit sequentially displays a right eye image and a left eye image according to an image synchronizing control signal. When the control unit receives the image synchronizing control signal, the control unit controls the phase modulator unit to switch to be a right eye phase or a left eye phase and controls the backlight unit to turn on or turn off according to the image synchronizing control signal.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a three-dimensional (3D) display according to an embodiment of the disclosure.

FIG. 2A and FIG. 2B are schematic diagrams illustrating operation methods of the 3D display of FIG. 1.

FIGS. 3A-3D are schematic diagrams illustrating a frame refreshing process of a display panel unit of the 3D display of FIG. 1.

FIGS. 4-10 are schematic diagrams of driving methods of a 3D display according to a plurality of embodiments of the disclosure.

FIG. 11 is a schematic diagram of a 3D display according to another embodiment of the disclosure.

FIG. 12 and FIG. 13 are schematic diagrams of driving methods of a 3D display according to a plurality of embodiments of the disclosure.

### DETAILED DESCRIPTION OF DISCLOSED EMBODIMENTS

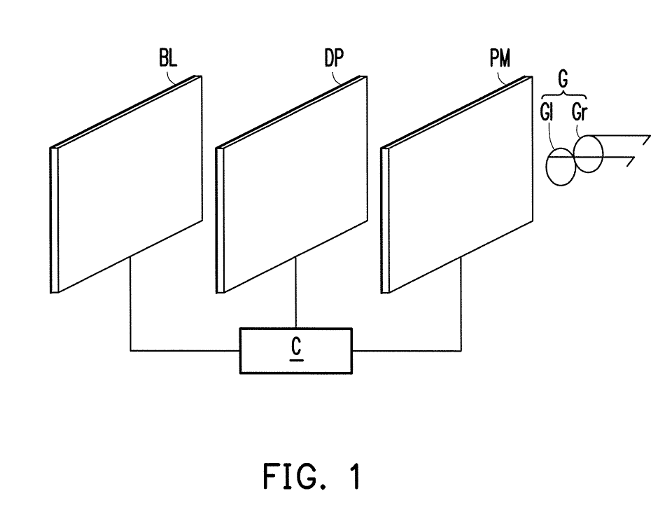

FIG. 1 is a schematic diagram of a three-dimensional (3D) display according to an embodiment of the disclosure. Referring to FIG. 1, the 3D display of the embodiment includes a display panel unit DP, a backlight unit BL, a phase modulator unit PM and a control unit C. In the present embodiment, the 3D display further includes a polarizing glasses G.

The display panel unit DP includes a display panel and a driving circuit, and the driving circuit is used for controlling image display of the display panel. In the present embodiment, the display panel is a liquid crystal display (LCD) panel. Generally, the LCD panel includes an active device array substrate, a color filter array substrate and a liquid crystal layer disposed between the two substrates. However, the display panel is not limited to be the LCD panel, and other non-self-luminous display panels can also be applied to the 3D display of the disclosure.

As described above, the active device array substrate generally includes a plurality of scan lines, a plurality of data lines and a plurality of pixel structures, where each of the scan lines and each of the data lines control the corresponding pixel structure. The scan lines and the data line are electrically connected to the driving circuit. The driving circuit transmits image data signals to the pixel structures through the scan lines and the data lines, and the display panel accordingly displays specific images. In detail, a synchronizing vertical signal provided by the driving circuit is transmitted to the pixel structures through the data lines, and the display panel display an image according to the synchronizing vertical signal provided by the driving circuit.

Since the display panel unit DP of the embodiment is applied in the 3D display, the display panel unit DP displays left eye images and right eye images in a page-lipping typed display manner according to the image synchronizing control signal. The left eye image and the right eye image have a certain disparity, and when a user views the left eye image through the left eye and views the right eye image through the right eye, the left and right eye images having the disparity form a 3D image having a depth perception in the user's brain. Moreover, since the right eye image and the left eye image displayed by the display panel unit DP are not specifically polarized, a polarizer can be disposed on the display panel unit DP to polarize the left eye image and the right eye image.

The backlight unit BL provides a light source to the display panel unit DP. Generally, the backlight unit BL is disposed at the back of the display panel unit DL, and the backlight unit BL includes a backlight device and a backlight driving circuit used for driving the backlight device to emit light. The backlight device can be a direct type backlight module or an edge type backlight module. A light source used in the backlight device can be a light emitting diode, a lamp or other suitable light sources. In the present embodiment, the backlight unit BL takes the image synchronizing control signal as a control signal for turning on/off. Therefore, the backlight unit BL is repeatedly turned on and turned off to present a bright state and a dark state in alternation during an operating or display period of the 3D display. Namely, the backlight unit BL is not continuously turned on or continuously in the bright state during the operating or display period of the 3D display.

In order to ensure the left eye and the right eye of the user to respectively view the left eye images and the right eye images, the 3D display of the present embodiment further includes the phase modulator unit PM. The phase modulator unit PM is disposed at one side of the display panel unit DP, and the display panel unit DP is located between the backlight unit BL and the phase modulator unit PM. The phase modulator unit PM can adjust polarities of the right eye image and the left eye image of the display panel unit DP. In the present embodiment, the phase modulator unit PM takes the image synchronizing control signal as the control signal to sequentially switch to be a right eye phase and a left eye phase.

The control unit C is electrically connected to the display panel unit DP, the phase modulator unit PM and the backlight unit BL, and controls the phase modulator unit PM to sequentially switch to be the right eye phase and the left eye phase, and controls the backlight unit BL to turn on and turn off repeatedly. In other words, when the control unit C receives the image synchronizing control signal, the control unit C takes the image synchronizing control signal as a control signal to control the phase modulator unit PM to be the right eye phase or the left eye phase, and controls the backlight unit BL to turn on or turn off.

The polarizing glasses G has a right lens and a left lens, and a polarity of the right lens and a polarity of the left lens are respectively coincided with the right eye phase and the left eye phase of the phase modulator unit PM. Therefore, when the user wears the polarizing glasses G, since the polarity of the right lens and the polarity of the left lens are respectively complied with the right eye phase and the left eye phase of the phase modulator unit PM, the right eye and the left eye of the user can respectively view the right eye images and the left eye images according to the switch operation of the phase modulator unit PM.

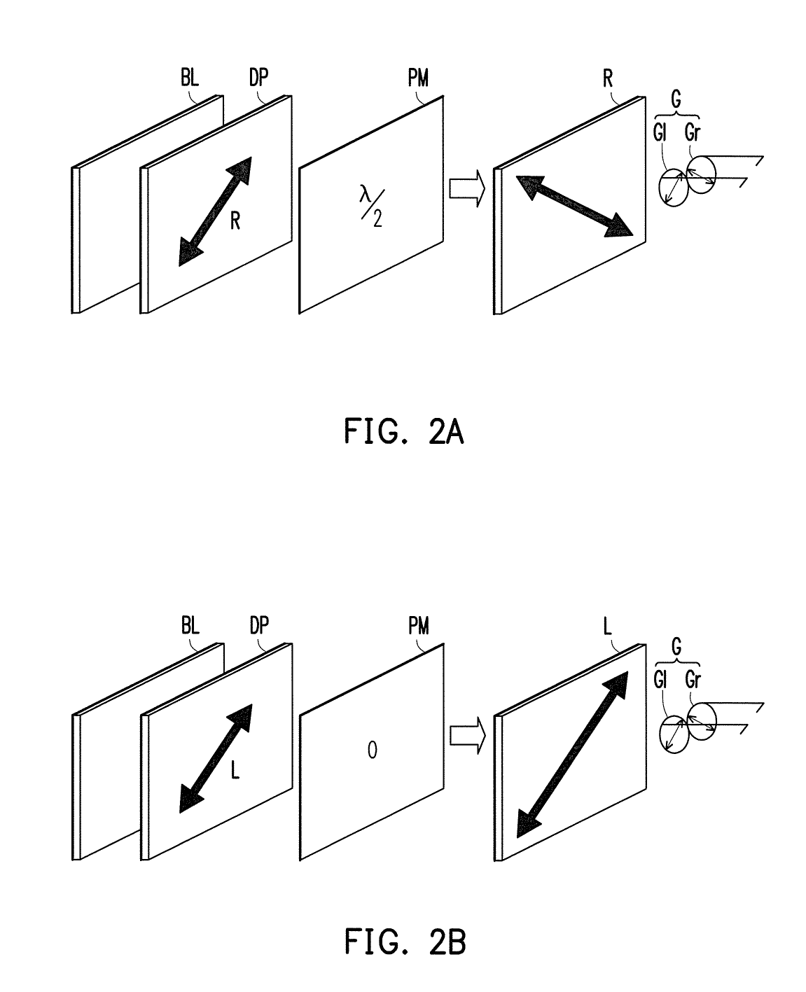

In detail, as shown in FIG. 2A, when the display panel unit DP displays a right eye image R, the right eye image R has a specific polarity. Then, when the right eye image R passes through the phase modulator unit PM (which has, for example, λ/2 retardation), the polarity of the right eye image R is adjusted to be the right eye phase. Then, since the right eye image R with the right eye phase has the same polarity with that of the right lens Gr of the polarizing glasses G, the right eye image R can pass through the right lens Gr to reach the right eye of the user. Now, since the polarity of the right eye image R is different to the polarity of the left lens G1 of the polarizing glasses G, the right eye image R cannot pass through the left lens G1 to reach the left eye of the user.

Then, as shown in FIG. 2B, when the display panel unit DP displays a left eye image L, the left eye image L also has a specific polarity. Then, when the left eye image L passes through the phase modulator unit PM (which has, for example, 0 retardation), the polarity of the left eye image L is adjusted to be the left eye phase. Then, since the left eye image L with the left eye phase has the same polarity with that of the left lens G1 of the polarizing glasses G, the left eye image L can pass through the left lens G1 to reach the left eye of the user. Now, since the polarity of the left eye image L is different to the polarity of the right lens Gr of the polarizing glasses G, the left eye image L cannot pass through the right lens Gr to reach the right eye of the user.

Therefore, according to the operation methods of FIG. 2A and FIG. 2B, the left eye image L and the right eye image R of the display panel unit DP can be respectively received by the left eye and the right eye of the user.

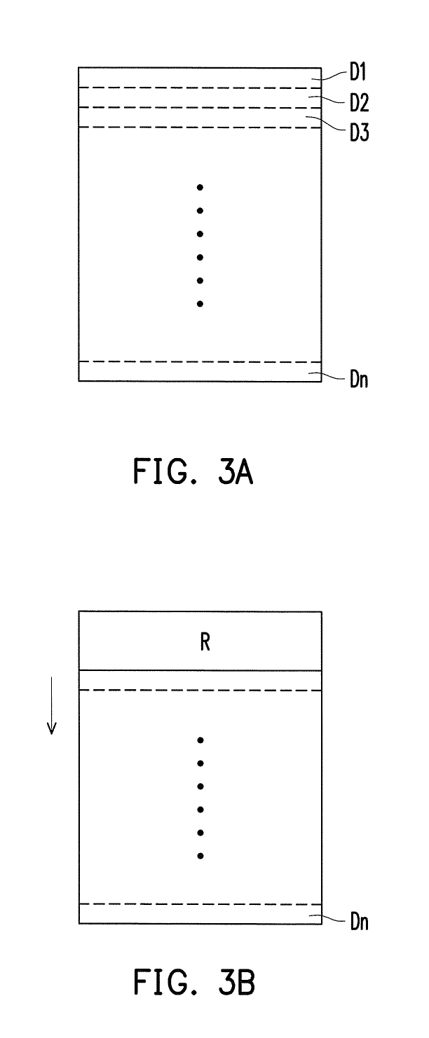

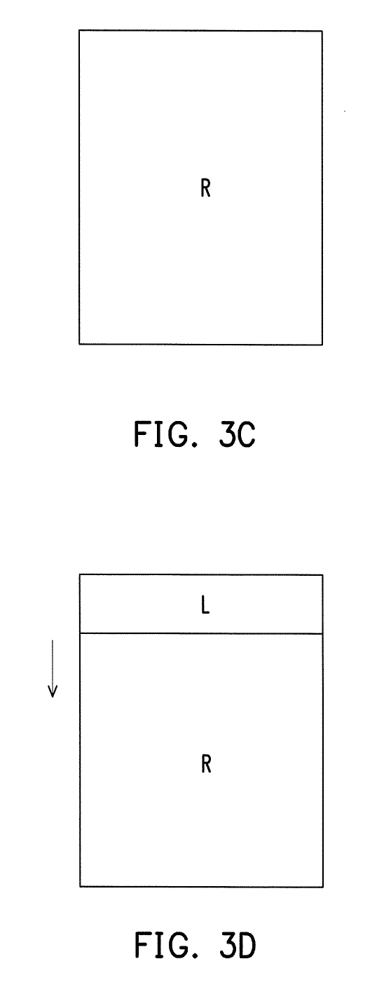

In the aforementioned 3D display, when the display panel unit DP displays images, it maintains image data until the image data is refreshed, as that shown in FIG. 3A to FIG. 3D. In detail, referring to FIG. 3A, the display panel unit DP has N image data regions D1˜Dn. When the display panel unit DP displays the right eye image R, the right eye image R is sequentially refreshed downwards from the first image data region D1, as that shown in FIG. 3B. Finally, after refreshing of the Nth image data region Dn (i.e. the last image data region) is completed, the right eye image R is completely displayed on the display panel unit DP, as that shown in FIG. 3C. Then, when the display panel unit DP starts to display the left eye image L, the left eye image L is sequentially refreshed downwards from the first image data region D1, as that shown in FIG. 3D until refreshing of the Nth image data region Dn (i.e. the last image data region) is completed.

Generally, an image refreshing rate of the display panel unit DP is limited due to a characteristic of a display medium thereof (for example, liquid crystal molecules), so that the display panel unit DP has a poor display quality when displaying dynamic images. Conventionally, in order to resolve the problem of limited image refreshing rate of the display panel unit DP, a scanning backlight module is used to improve the display quality of the dynamic images. However, usage of the scanning backlight module is liable to cause flicking of the displayed image of the display panel unit DP, which may fatigue the user's eyes when the user watches the images for some time. Particularly, as the 3D display uses the phase modulator unit PM, the above problem of poor dynamic image display quality and the flicking problem can be aggravated, which may even lead to a ghost phenomenon.

In order to resolve the poor display quality of the 3D display, a plurality of driving methods are provided below for driving the 3D display.

It should be noticed that in the present embodiment, if a response time of the display panel unit DP is t1, a response time of the phase modulator unit PM is t2, and a response time of the backlight unit BL is t3, the time relationship of t1, t2 and t3 is t3<<t2<t1. In other words, the response time t3 of the backlight unit BL is far smaller than the response time t2 of the phase modulator unit PM, and the response time t2 of the phase modulator unit PM is smaller than the response time t1 of the display panel unit DP. Namely, a response rate of the backlight unit BL is higher than a response rate of the phase modulator unit PM, and the response rate of the phase modulator unit PM is higher than a response rate of the display panel unit DP. Therefore, the disclosure provides several driving methods according to the relationship of the response time/response rate of the display panel unit DP, the phase modulator unit PM and the backlight unit BL, so as to improve the whole display quality of the 3D display.

### First Embodiment

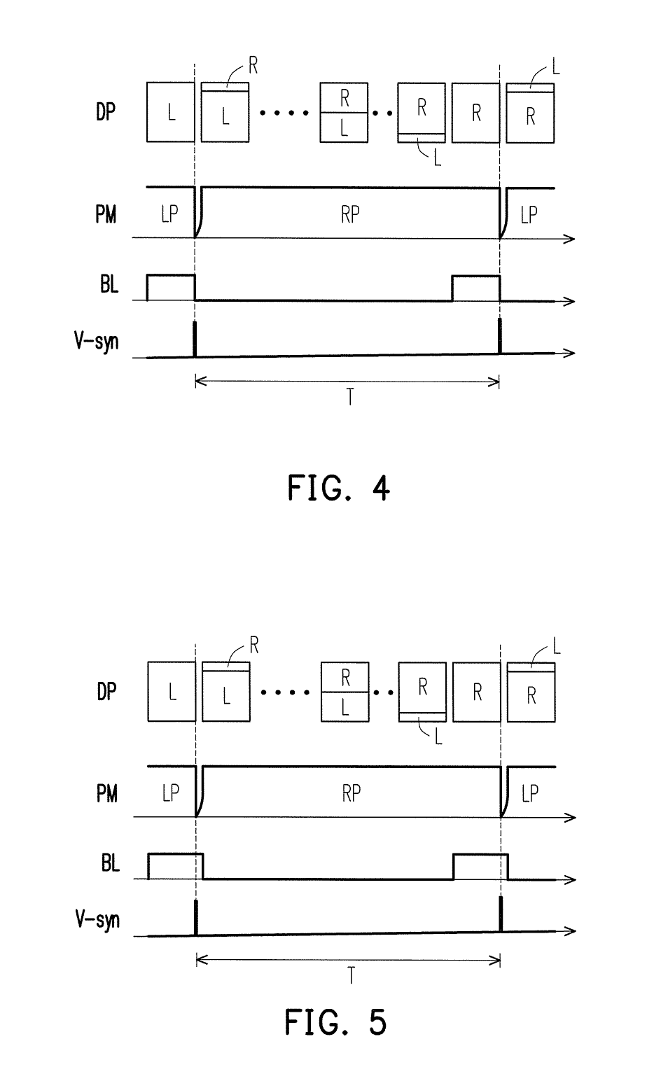

FIG. 4 is a schematic diagram of a driving method of a 3D display according to an embodiment of the disclosure. Referring to FIG. 1 and FIG. 4, in the present embodiment, the display panel unit DP sequentially displays the right eye image R and the left eye image L according to an image synchronizing control signal V-syn, and a refreshing time of each of the images (the right eye image R or the left eye image L) from the first image data region D1 to the Nth image data region Dn (shown in FIG. 3A) is T. In detail, when the control unit C receives the image synchronizing control signal V-syn, the control unit C controls the display panel unit DP to start refreshing the right eye image R from the first image data region D1. When the control unit C receives a next image synchronizing control signal V-syn, the control unit C controls the display panel unit DP to start refreshing the left eye image L from the first image data region D1. In the present embodiment, the refreshing time T of each of the images (the right eye image R or the left eye image L) is, for example, 1/120 second, though the disclosure is not limited thereto.

It should be noticed that refreshing of the right eye image R (or the left eye image L) is synchronized to the image synchronizing control signal V-syn. The synchronization includes that a refreshing start time of the right eye image R (or the left eye image L) is completely coincided with the image synchronizing control signal V-syn, or the refreshing start time of the right eye image R (or the left eye image L) is a little bit ahead of or behind the image synchronizing control signal V-syn.

As described above, when the control unit C receives the image synchronizing control signal V-syn corresponding to the right eye image R, the control unit C controls the phase modulator unit PM to switch to be a right eye phase RP. Now, the right eye image R of the display panel unit DP passing through the phase modulator unit PM is adjusted to a phase having a same polarization direction with that of the right lens Gr of the polarizing glasses G, so that the right eye image R can pass through the right lens Gr of the polarizing glasses G. Similarly, when the control unit C receives the image synchronizing control signal V-syn corresponding to the left eye image L, the control unit C controls the phase modulator unit PM to switch to be a left eye phase LP. Now, the left eye image L of the display panel unit DP passing through the phase modulator unit PM is adjusted to a phase having a same polarization direction with that of the left lens G1 of the polarizing glasses G, so that the left eye image L can pass through the left lens G1 of the polarizing glasses G.

Similarly, when the control unit C receives the image synchronizing control signal V-syn corresponding to the right eye image R, the control unit C controls the backlight unit BL to turn on after the (N-1)th image data region Dn-1 of the right eye image R is refreshed, and when the control unit C receives the image synchronizing control signal V-syn corresponding to the left eye image L, the control unit C controls the backlight unit BL to turn off. In other words, in the present embodiment, the backlight unit BL is tuned on after the display panel unit DP completes refreshing the (N-1)th image data region, and is turned off until a next image synchronizing control signal V-syn is generated.

Therefore, in the present embodiment, when the image (the right eye image R or the left eye image L) of the display panel unit DP is in a refreshing process from the first image data region D1 to the (N-1)th image data region Dn-1, since the backlight unit BL is in a turn-off state, the user cannot view the image in the refreshing process. The backlight unit BL is turned on after the display panel unit DP completes refreshing the (N-1)th image data region Dn-1 of the image (the right eye image R or the left eye image L), so that the user can view refreshing of the Nth image data region Dn of the image (the right eye image R or the left eye image L) and a frame after the image (the right eye image R or the left eye image L) is refreshed. Therefore, the driving method of the present embodiment can mitigate the problem of poor 3D display quality caused by refreshing of the frame of the display panel unit DP.

FIG. 5 is a schematic diagram of a driving method of a 3D display according to an embodiment of the disclosure. Referring to FIG. 1 and FIG. 5, in the embodiment of FIG. 5, similar to the embodiment of FIG. 4, the display panel unit DP also sequentially displays the right eye image R and the left eye image L, and the phase modulator unit PM also sequentially switches to be the right eye phase RP and the left eye phase LP. A difference between the embodiment of FIG. 5 and the embodiment of FIG. 4 is that besides the backlight unit BL is turned on after the (N-1)th image data region of the image (the right eye image R or the left eye image L) of the display panel unit DP is refreshed, the backlight unit BL is turned off until the phase modulator unit PM is fully switched to the right eye phase RP or the left eye phase LP. Therefore, a turn-on time of the backlight unit BL is longer than that of the embodiment of FIG. 4.

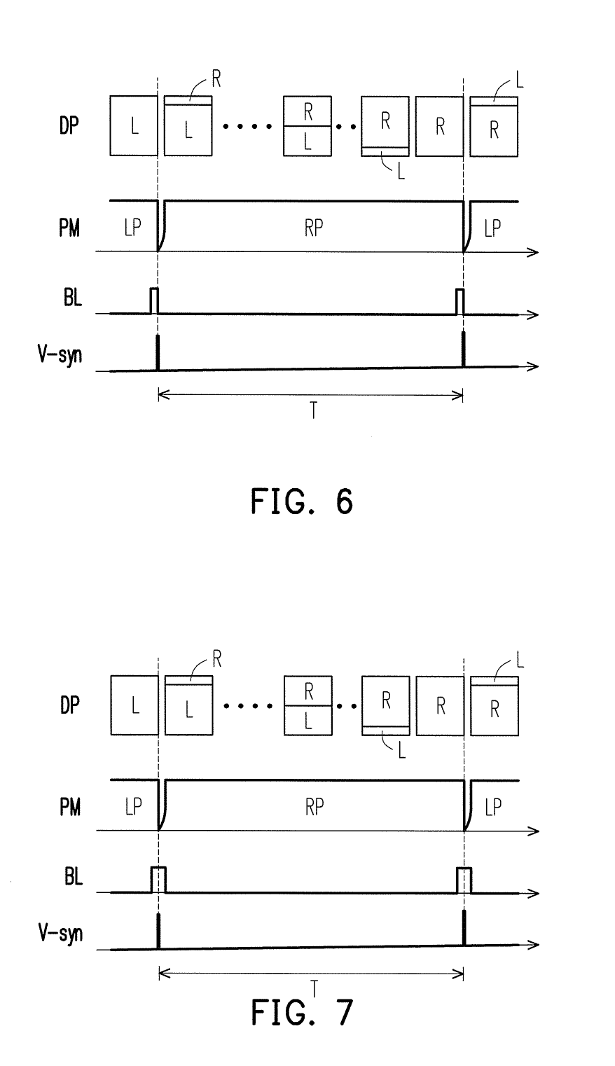

FIG. 6 is a schematic diagram of a driving method of a 3D display according to an embodiment of the disclosure. Referring to FIG. 1 and FIG. 6, in the embodiment of FIG. 6, similar to the embodiment of FIG. 4, the display panel unit DP also sequentially displays the right eye image R and the left eye image L, and the phase modulator unit PM also sequentially switches the right eye phase RP and the left eye phase LP. A difference between the embodiment of FIG. 6 and the embodiment of FIG. 4 is that when the control unit C receives the image synchronizing control signal V-syn corresponding to the right eye image R, the control unit C controls the backlight unit BL to turn on after the Nth image data region of the image (the right eye image R or the left eye image L) of the display panel unit DP is refreshed, and when the control unit C (shown in FIG. 1) receives the image synchronizing control signal V-syn corresponding to the left eye image L, the control unit C controls the backlight unit BL to turn off. In other words, in the present embodiment, the backlight unit BL is turned on after the display panel unit DP completes refreshing all of the image data regions of the image (the right eye image R or the left eye image L), and is turned off after the next image synchronizing control signal V-syn is generated.

Therefore, in the present embodiment, when the image (the right eye image R or the left eye image L) of the display panel unit DP is in a refreshing process from the first image data region D1 to the Nth image data region Dn, since the backlight unit BL is in the turn-off state, the user cannot view the image in the refreshing process. The backlight unit BL is turned on after the display panel unit DP completes refreshing the all of the image data regions of the image (the right eye image R or the left eye image L), so that the user can view a refreshed frame of the display panel unit DP. Therefore, the driving method of the present embodiment can further mitigate the problem of poor 3D display quality caused by refreshing of the frame of the display panel unit DP.

FIG. 7 is a schematic diagram of a driving method of a 3D display according to an embodiment of the disclosure. Referring to FIG. 1 and FIG. 7, in the embodiment of FIG. 7, similar to the embodiment of FIG. 6, the display panel unit DP also sequentially displays the right eye image R and the left eye image L, and the phase modulator unit PM also sequentially switches to be the right eye phase RP and the left eye phase LP. A difference between the embodiment of FIG. 7 and the embodiment of FIG. 6 is that besides the backlight unit BL is turned on after the Nth image data region of the image (the right eye image R or the left eye image L) of the display panel unit DP is refreshed, the backlight unit BL is turned off until the phase modulator unit PM is fully switched to be the right eye phase RP or the left eye phase LP. Therefore, the turn-on time of the backlight unit BL is longer than that of the embodiment of FIG. 6.

### Second Embodiment

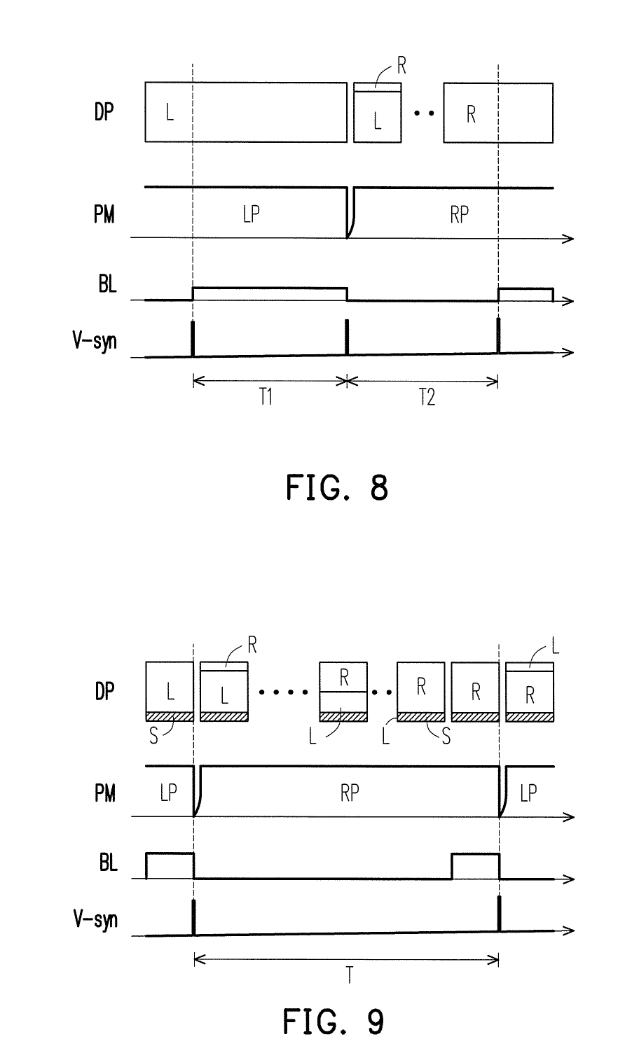

FIG. 8 is a schematic diagram of a driving method of a 3D display according to an embodiment of the disclosure. Referring to FIG. 1 and FIG. 8, in the present embodiment, a period for the display panel unit DP displaying the right eye image R (or the left eye image L) includes a first time interval T1 and a second time interval T2. Here, the first time interval T1 and the second time interval T2 are, for example, respectively 1/240 second, though the disclosure is not limited thereto.

As described above, the display panel unit DP continuously displays a previous image (for example, the left eye image L) in the first time interval T1, and refreshes the image (for example, the right eye image R) in the second time interval T2.

When the control unit C receives the image synchronizing control signal V-syn corresponding to the left eye image L, the control unit C controls the phase modulation unit PM to present the left eye phase LP in the first time interval T1. When the control unit C receives the image synchronizing control signal V-syn corresponding to the right eye image R (the second time inverter T2 is entered), the control unit C controls the phase modulation unit PM to present the right eye phase RP in the second time interval T2. Then, when the control unit C receives the next image synchronizing control signal V-syn, the control unit C controls the phase modulation unit PM to continuously present the right eye phase RP.

Moreover, when the control unit C receives the image synchronizing control signal V-syn corresponding to the left eye image L, the control unit C controls the backlight unit BL to turn on, and the backlight unit BL is maintained in the turn-on state in the first time interval T1. When the control unit C receives the image synchronizing control signal V-syn corresponding to the right eye image R (the second time inverter T2 is entered), the control unit C controls the backlight unit BL to turn off. Then, when the control unit C receives the next image synchronizing control signal V-syn, the control unit C controls the backlight unit BL to turn on.

In other words, in the present embodiment, when the display panel unit DP continuously displays the previous image (for example, the left eye image L) in the first time interval T1, the backlight unit BL is in the turn-on state, so that the left eye of the user can view the left eye image L. When the image (for example, the right eye image R) is refreshed in the second time interval T2, the backlight unit BL is in the turn-off state, so that the user cannot view the image in the refreshing process.

Since the turn-on time of the backlight unit BL of the present embodiment is relatively long, compared to the aforementioned embodiments, a backlight unit BL with a lower brightness can be used to reduce the cost of the backlight unit BL.

### Third Embodiment

FIG. 9 is a schematic diagram of a driving method of a 3D display according to an embodiment of the disclosure. Referring to FIG. 1 and FIG. 9, in the embodiment of FIG. 9, the 3D display further includes a shielding member S, which shields the Nth image data region Dn of the display panel unit DP.

Similarly, the display panel unit DP sequentially displays the right eye image R and the left eye image L, and a refreshing time of each of the images (the right eye image R or the left eye image L) from the first image data region D1 to the Nth image data region Dn is T. In the present embodiment, the refreshing time T of each of the images (the right eye image R or the left eye image L) is, for example, 1/120 second, though the disclosure is not limited thereto.

As described above, when the control unit C receives the image synchronizing control signal V-syn corresponding to the right eye image R, the control unit C controls the phase modulation unit PM to switch to be the right eye phase RP. When the control unit C receives the image synchronizing control signal V-syn corresponding to the left eye image L, the control unit C controls the phase modulation unit PM to switch to be the left eye phase LP.

Moreover, when the control unit C receives the image synchronizing control signal V-syn corresponding to the right eye image R, the control unit C controls the backlight unit BL to turn on after the (N-1)th image data region Dn-1 of the right eye image R is refreshed, and when the control unit C receives the image synchronizing control signal V-syn corresponding to the left eye image L, the control unit C controls the backlight unit BL to turn off. In other words, in the present embodiment, the backlight unit BL is tuned on after the display panel unit DP completes refreshing the (N-1)th image data region of the image (the right eye image R or the left eye image L), and is turned off until a next image synchronizing control signal V-syn is generated.

Therefore, in the present embodiment, when the image (the right eye image R or the left eye image L) of the display panel unit DP is in a refreshing process from the first image data region D1 to the (N-1)th image data region Dn-1, since the backlight unit BL is in the turn-off state, the user cannot view the image in, the refreshing process. The backlight unit BL is turned on after the display panel unit DP completes refreshing the (N-1)th image data region Dn-1 of the image (the right eye image R or the left eye image L). Now, since the Nth image data region Dn of the display panel unit DP is shielded by the shielding member S, the user cannot view a refreshing frame of the Nth image data region Dn of the image (the right eye image R or the left eye image L). Therefore, the driving method of the present embodiment can further improve the display quality of the 3D display.

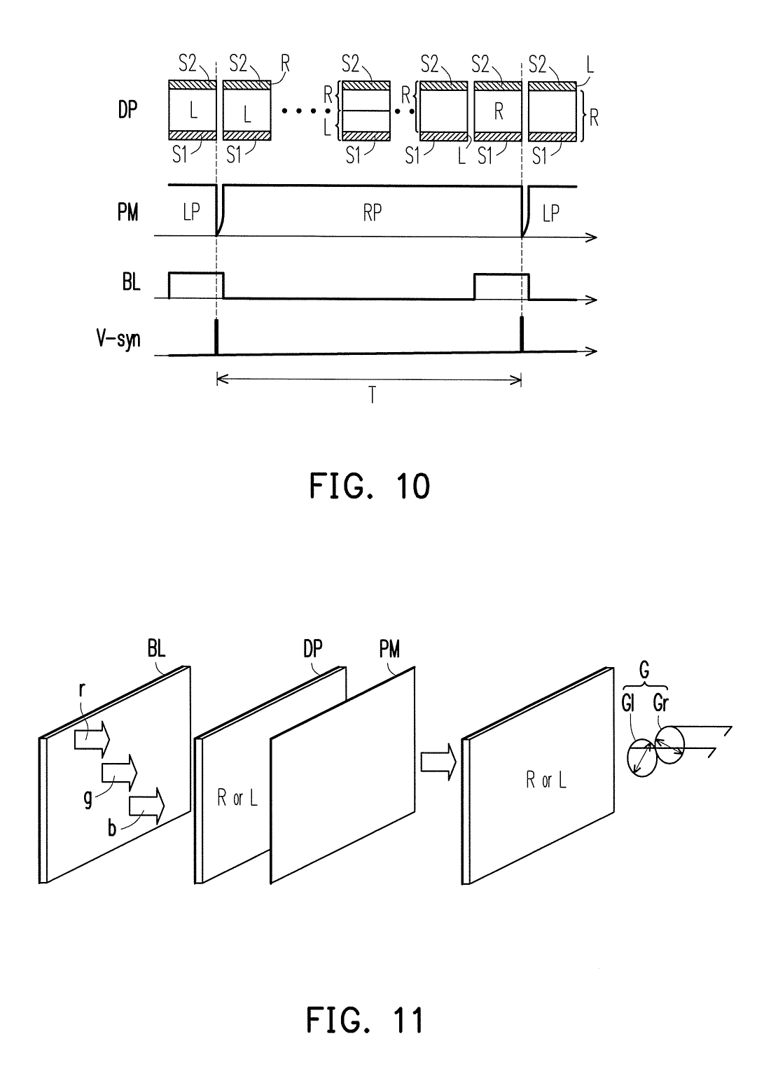

FIG. 10 is a schematic diagram of a driving method of a 3D display according to an embodiment of the disclosure. Referring to FIG. 1 and FIG. 10, in the embodiment of FIG. 10, the 3D display further includes shielding members S1 and S2, which shield the first image data region D1 and the Nth image data region Dn (as shown in FIG. 3A) of the display panel unit DP.

Similarly, the display panel unit DP sequentially displays the right eye image R and the left eye image L, and a refreshing time of each of the images (the right eye image R or the left eye image L) from the first image data region D1 to the Nth image data region Dn is T. In the present embodiment, the refreshing time T of each of the images (the right eye image R or the left eye image L) is, for example, 1/120 second, though the disclosure is not limited thereto.

As described above, when the control unit C receives the image synchronizing control signal V-syn corresponding to the right eye image R, the control unit C controls the phase modulation unit PM to switch to be the right eye phase RP. When the control unit C receives the image synchronizing control signal V-syn corresponding to the left eye image L, the control unit C controls the phase modulation unit PM to switch to be the left eye phase LP.

Moreover, when the control unit C receives the image synchronizing control signal V-syn corresponding to the right eye image R, the control unit C controls the backlight unit BL to turn on after the (N-1)th image data region Dn-1 of the right eye image R is refreshed, and the backlight unit BL is kept turning on until the phase modulator unit PM is fully switched to the left eye phase LP.

In the present embodiment, when the image (the right eye image R or the left eye image L) of the display panel unit DP is in a refreshing process from the first image data region D1 to the (N-1)th image data region Dn-1, since the backlight unit BL is in the turn-off state, the user cannot view the image in the refreshing process. The backlight unit BL is turned on after the display panel unit DP completes refreshing the (N-1)th image data region Dn-1 of the image (the right eye image R or the left eye image L), and is kept turning on until the phase modulator unit PM is fully switched to a next phase state. Now, since the Nth image data region Dn of the display panel unit DP is shielded by the shielding member Si, the user cannot view a refreshing frame of the Nth image data region Dn, but only view a refreshed frame of the display panel unit DP. Moreover, although the backlight unit BL is kept turning on until the phase modulator unit PM is fully switched to the next phase state, since the first image data region of the display panel unit DP is shielded by the shielding member S2, the user cannot view a refreshing frame of the first image data region. Therefore, the driving method of the present embodiment can further improve the display quality of the 3D display.

### Fourth Embodiment

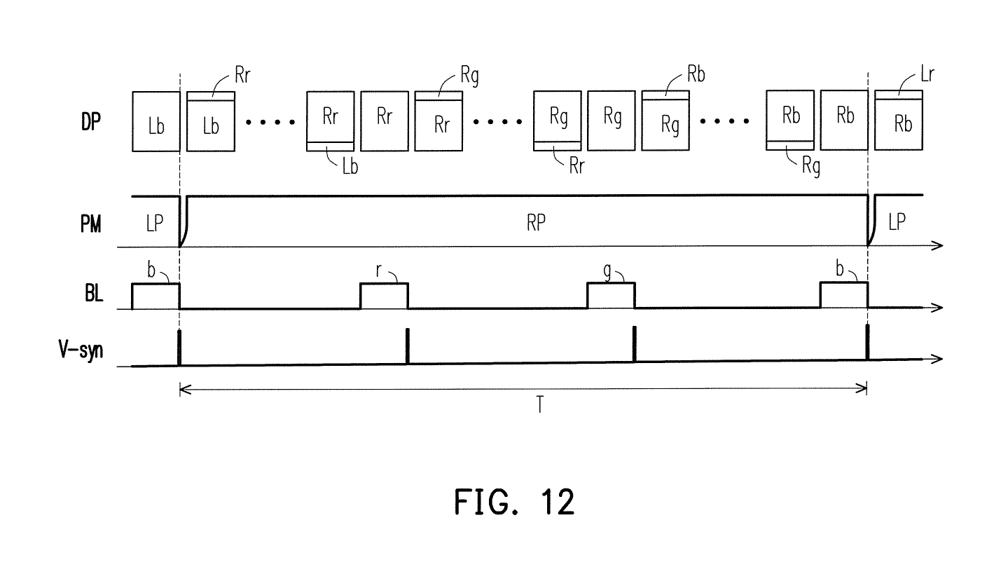

FIG. 11 is a schematic diagram of a 3D display according to another embodiment of the disclosure. FIG. 12 is a schematic diagram of a driving method of a 3D display according to an embodiment of the disclosure. Referring to FIG. 1, FIG. 11 and FIG. 12, in the present embodiment, the backlight unit BL includes a first color light source r, a second color light source g and a third color light source b, and the first color light source r, the second color light source g and the third color light source b are sequentially turned on. The first color light source r, the second color light source g and the third color light source b are, for example, respectively a red light source, a green light source and a blue light source.

The display panel unit DP sequentially displays the right eye image R and the left eye image L. Particularly, the right eye image R of the display panel unit DP includes a right eye first color image Rr, a right eye second color image Rg and a right eye third color image Rb, and the left eye image L includes a left eye first color image Lr, a left eye second color image Lg and a left eye third color image Lb. The right eye first color image Rr, the right eye second color image Rg and the right eye third color image Rb are, for example, a right eye red image Rr, a right eye green image Rg and a right eye blue image Rb. The left eye first color image Lr, the left eye second color image Lg and the left eye third color image Lb are, for example, a left eye red image Lr, a left eye green image Lg and a left eye blue image Lb. When the display panel unit DP displays the right eye image R, the right eye first color image Rr, the right eye second color image Rg and the right eye third color image Rb are sequentially displayed. When the display panel unit DP displays the left eye image L, the left eye first color image Lr, the left eye second color image Lg and the left eye third color image Lb are sequentially displayed.

Similarly, each of the images (the right eye image R or the left eye image L) of the display panel unit DP is sequentially refreshed from the first image data region D1 to the Nth image data region Dn. Therefore, regarding a refreshing method of the right eye image R of the display panel unit DP, the right eye first color image Rr is sequentially refreshed from the first image data region D1 to the Nth image data region Dn, and the right eye second color image Rg is sequentially refreshed from the first image data region D1 to the Nth image data region Dn, and then the right eye third color image Rb is sequentially refreshed from the first image data region D1 to the Nth image data region Dn. Similarly, regarding a refreshing method of the left eye image L of the display panel unit DP, the left eye first color image Lr is sequentially refreshed from the first image data region D1 to the Nth image data region Dn, and the left eye second color image Lg is sequentially refreshed from the first image data region D1 to the Nth image data region Dn, and then the left eye third color image Lb is sequentially refreshed from the first image data region D1 to the Nth image data region Dn.

In the present embodiment, the refreshing time T of each of the images (the right eye image R or the left eye image L) is, for example, 1/120 second, though the disclosure is not limited thereto.

As described above, when the control unit C receives the image synchronizing control signal V-syn corresponding to the right eye image R, the control unit C controls the phase modulation unit PM to switch to be the right eye phase RP. When the control unit C receives the image synchronizing control signal V-syn corresponding to the left eye image L, the control unit C controls the phase modulation unit PM to switch to be the left eye phase LP.

Moreover, when the control unit C receives the image synchronizing control signal V-syn corresponding to the right eye first color image Rr, the control unit C controls the backlight unit BL to turn off, and controls the first color light source r of the backlight unit BL to turn on after the (N-1)th image data region Dn-1 of the right eye first color image Rr is refreshed. When the control unit C receives the image synchronizing control signal V-syn corresponding to the right eye second color image Rg, i.e. when the display panel unit DP starts to refresh the first image data region D1 of the right eye second color image Rg, the control unit C controls the backlight unit BL to turn off Then, after the display panel unit DP refreshes the (N-1)th image data region Dn-1 of the right eye second color image Rg, the control unit C controls the second color light source g of the backlight unit BL to turn on. When the control unit C receives the image synchronizing control signal V-syn corresponding to the right eye third color image Rb, i.e. when the display panel unit DP starts to refresh the first image data region D1 of the right eye third color image Rb, the control unit C controls the backlight unit BL to turn off Then, after the display panel unit DP refreshes the (N-1)th image data region Dn-1 of the right eye third color image Rb, the control unit C controls the third color light source b of the backlight unit BL to turn on. Similarly, when the display panel unit DP sequentially refreshes the left eye first color image Lr, the left eye second color image Lg and the left eye third color image Lb, the first color light source r, the second color light source g and the third color light source b of the backlight unit BL are turned on and turned off according to the same method as that described above.

As described above, in the present embodiment, the first color light source r, the second color light source g and the third color light source b of the backlight unit BL are sequentially turned on according to refreshing of the left/right eye first color image, the left/right eye second color image and the left/right eye third color image of the display panel unit DP. Therefore, compared to the aforementioned embodiments, resolution and brightness of the 3D display of the present embodiment are increased by three times, and the display quality thereof is also improved.

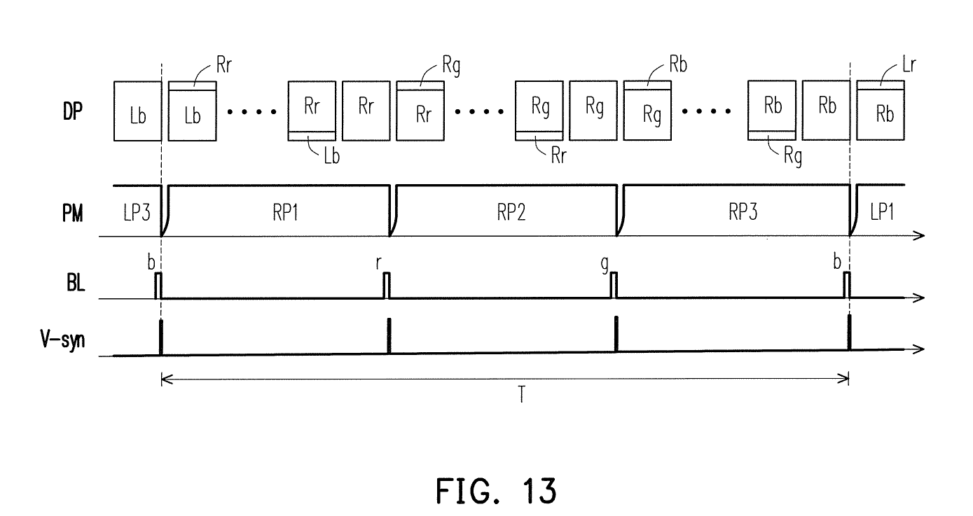

FIG. 13 is a schematic diagram of a driving method of a 3D display according to an embodiment of the disclosure. Referring to FIG. 1 and FIG. 13, in the present embodiment, the same to the embodiment of FIG. 12, the backlight unit BL also includes the first color light source r, the second color light source g and the third color light source b, and the first color light source r, the second color light source g and the third color light source b are sequentially turned on. Moreover, the same to the embodiment of FIG. 12, the display panel unit DP of the present embodiment sequentially displays the right eye image R and the left eye image L. Similarly, the right eye image R of the display panel unit DP includes the right eye first color image Rr, the right eye second color image Rg and the right eye third color image Rb, and the left eye image L includes the left eye first color image Lr, the left eye second color image Lg and the left eye third color image Lb. When the display panel unit DP displays the right eye image R, the right eye first color image Rr, the right eye second color image Rg and the right eye third color image Rb are sequentially displayed. When the display panel unit DP displays the left eye image L, the left eye first color image Lr, the left eye second color image Lg and the left eye third color image Lb are sequentially displayed.

In the present embodiment, the refreshing time T of each of the images (the right eye image R or the left eye image L) is, for example, 1/120 second, though the disclosure is not limited thereto.

In the present embodiment, when the control unit C receives the image synchronizing control signal V-syn corresponding to the right eye first color image Rr, the control unit C controls the phase modulator unit PM to switch to be a first right eye phase RP1. Then, when the control unit C receives the image synchronizing control signal V-syn corresponding to the right eye second color image Rg, the control unit C controls the phase modulator unit PM to switch to be a second right eye phase RP2. Then, when the control unit C receives the image synchronizing control signal V-syn corresponding to the right eye third color image Rb, the control unit C controls the phase modulator unit PM to switch to be a third right eye phase RP3. Similarly, when the control unit C receives the image synchronizing control signals V-syn corresponding to the left eye first color image Lr, the left eye second color image Lg and the left eye third color image Lb, the control unit C controls the phase modulator unit PM to sequentially switch to be a first left eye phase LP1, a second left eye phase LP2 and a third left eye phase LP3.

As describe above, when the control unit C receives the image synchronizing control signal V-syn corresponding to the right eye first color image Rr, the control unit C controls the first color light source r of the backlight unit BL to turn on after the Nth image data region Dn of the right eye first color image Rr is refreshed. When the control unit C receives the image synchronizing control signal V-syn corresponding to the right eye second color image Rg, i.e. when the display panel unit DP starts to refresh the first image data region D1 of the right eye second color image Rg, the control unit C controls the backlight unit BL to turn off Then, after the display panel unit DP refreshes the Nth image data region Dn of the right eye second color image Rg, the control unit C controls the second color light source g of the backlight unit BL to turn on. When the control unit C receives the image synchronizing control signal V-syn corresponding to the right eye third color image Rb, i.e. when the display panel unit DP starts to refresh the first image data region D1 of the right eye third color image Rb, the control unit C controls the backlight unit BL to turn off. Then, after the display panel unit DP refreshes the Nth image data region Dn of the right eye third color image Rb, the control unit C controls the third color light source b of the backlight unit BL to turn on. Similarly, when the display panel unit DP sequentially refreshes the left eye first color image Lr, the left eye second color image Lg and the left eye third color image Lb, the first color light source r, the second color light source g and the third color light source b of the backlight unit BL are turned on/off according to the same method as that described above.

As described above, in the present embodiment, the phase modulator unit PM sequentially switches to be the first left/right phase, the second left/right phase and the third left/right phase according to refreshing of the left/right eye first color image, the left/right eye second color image and the left/right eye third color image of the display panel unit DP. Moreover, the first color light source r, the second color light source g and the third color light source b of the backlight unit BL are sequentially turned on according to refreshing of the left/right eye first color image, the left/right eye second color image and the left/right eye third color image of the display panel unit DP. Therefore, besides the resolution and brightness of the 3D display of the present embodiment are increased, by adjusting retardations of the left/right eye first color image, the left/right eye second color image and the left/right eye third color image, a color shift problem of the 3D display is mitigated.

It should be noticed that in any of the aforementioned embodiments, the backlight unit BL of the 3D display can be designed to simultaneously have a 3D displaying driving mode and a two dimension displaying driving mode. The 3D displaying driving mode is the driving method of the backlight unit BL of any of the embodiments of FIG. 4-FIG. 10 and FIG. 12-FIG. 13. The two dimension displaying driving mode is a driving mode of a backlight module of a conventional display, which is, for example, a scanning driving mode, a continuous turn-on driving mode or other driving modes. In other words, when the user wants to view the 3D images through the 3D display, the aforementioned 3D displaying driving mode can be used to drive the backlight unit BL of the 3D display, so as to improve the display quality of the 3D images. When the user wants to view two dimension images through the display, the two dimension displaying driving mode can be used to drive the backlight unit BL of the display.

In summary, the backlight unit of the 3D display is turned on/off according to a right eye synchronizing vertical signal or a left eye synchronizing vertical signal, so that a user does not view the right eye image and the left eye image in a refreshing state. In other words, the image in the refreshing state on the display panel unit cannot be viewed due to that the backlight unit is turned off Therefore, the user can view a better 3D image through the 3D display without having an uncomfortable feeling.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A three-dimensional display, comprising:
a display panel unit, sequentially displaying a right eye image and a left eye image according to an image synchronizing control signal;
a phase modulator unit, disposed at one side of the display panel unit, and being sequentially switched to be a right eye phase and a left eye phase;
a backlight unit, disposed at the other side of the display panel unit, and being repeatedly turned on and turned off; and
a control unit, electrically connected to the display panel unit, the phase modulator unit and the backlight unit, controlling the phase modulator unit to sequentially switch to be the right eye phase and the left eye phase, and controlling the backlight unit to turn on and turn off repeatedly.

2. The three-dimensional display as claimed in claim 1, wherein the display panel unit has N image data regions, and the display panel unit sequentially refreshes a first image data region to an Nth image data region when displaying the right eye image or the left eye image.

3. The three-dimensional display as claimed in claim 2, wherein
the backlight unit is turned on after the (N-1)th image data region of the right eye image or the left eye image is refreshed, and
the backlight unit is turned off when a next left eye image or right eye image is started to be refreshed.

4. The three-dimensional display as claimed in claim 3, further comprising a shielding member to shield the Nth image data region of the display panel unit.

5. The three-dimensional display as claimed in claim 3, wherein
the backlight unit is turned on after the (N-1)th image data region of the right eye image or the left eye image is refreshed, and
the backlight unit is turned off when the phase modulator unit is fully switched to be the right eye phase or the left eye phase.

6. The three-dimensional display as claimed in claim 5, further comprising a shielding member to shield the first image data region and the Nth image data region of the display panel unit.

7. The three-dimensional display as claimed in claim 2, wherein
the backlight unit is turned on after the Nth image data region of the right eye image or the left eye image is refreshed, and
the backlight unit is turned off when a next left eye image or right eye image is started to be refreshed.

8. The three-dimensional display as claimed in claim 2, wherein
the backlight unit is turned on after the Nth image data region of the right eye image or the left eye image is refreshed, and
the backlight unit is turned off when the phase modulator unit is fully to switched be the right eye phase or the left eye phase.

9. The three-dimensional display as claimed in claim 1, wherein a period for the display panel unit displaying the right eye image or the left eye image comprises a first time interval and a second time interval,
the display panel unit fully displays the right eye image or the left eye image in the first time interval, and the display panel unit refreshes a next left eye image or a next right eye image in the second time interval, and
the backlight unit is in a turn-on state in the first time interval and is in a turn-off state in the second time interval.

10. The three-dimensional display as claimed in claim 1, wherein
the right eye image of the display panel unit further comprises a right eye first color image, a right eye second color image and a right eye third color image, and the right eye first color image, the right eye second color image and the right eye third color image are sequentially displayed,
the left eye image of the display panel unit further comprises a left eye first color image, a left eye second color image and a left eye third color image, and the left eye first color image, the left eye second color image and the left eye third color image are sequentially displayed,
the backlight unit comprises a first color light source, a second color light source and a third color light source, wherein the first color light source, the second color light source and the third color light source are turned on according to the displaying of the right eye first color image, the right eye second color image and the right eye third color image, and
the first color light source, the second color light source and the third color light source are turned on according to the displaying of the left eye first color image, the left eye second color image and the left eye third color image.

11. The three-dimensional display as claimed in claim 10, wherein
the right eye phase of the phase modulator unit comprises a first right eye phase, a second right eye phase and a third right eye phase, wherein the first right eye phase, the second right eye phase and the third right eye phase are switched according to the displaying of the right eye first color image, the right eye second color image and the right eye third color image, and
the left eye phase of the phase modulator unit comprises a first left eye phase, a second left eye phase and a third left eye phase, wherein the first left eye phase, the second left eye phase and the third left eye phase are switched according to the displaying of the left eye first color image, the left eye second color image and the left eye third color image.

12. The three-dimensional display as claimed in claim 1, further comprising a polarizing glasses having a right lens and a left lens, wherein a polarity of the right lens and a polarity of the left lens are respectively coincided with the right eye phase and the left eye phase.

13. A driving method of a three-dimensional display, comprising:
providing a three-dimensional display comprising a display panel unit, a phase modulator unit, a backlight unit and a control unit;
the display panel unit sequentially displaying a right eye image and a left eye image according to an image synchronizing control signal; and
the control unit controlling the phase modulator unit to switch to be a right eye phase and a left eye phase and controlling the backlight unit to turn on and turn off.

14. The driving method of the three-dimensional display as claimed in claim 13, wherein the display panel unit has N image data regions, and the display panel unit sequentially refreshes a first image data region to an Nth image data region when displaying the right eye image or the left eye image.

15. The driving method of the three-dimensional display as claimed in claim 14, wherein
the control unit controls the backlight unit to turn on after the (N-1)th image data region of the right eye image or the left eye image is refreshed, and
the control unit controls the backlight unit to turn off when a next left eye image or right eye image is started to be refreshed.

16. The driving method of the three-dimensional display as claimed in claim 15, further comprising a shielding member to shield the Nth image data region of the display panel unit.

17. The driving method of the three-dimensional display as claimed in claim 14, wherein
the control unit controls the backlight unit to turn on after the (N-1)th image data region of the right eye image or the left eye image is refreshed, and
the control unit controls the backlight unit to turn off when the phase modulator unit is fully switched to be the right eye phase or the left eye phase.

18. The driving method of the three-dimensional display as claimed in claim 17, further comprising a shielding member to shield the first image data region and the Nth image data region of the display panel unit.

19. The driving method of the three-dimensional display as claimed in claim 14, wherein
the control unit controls the backlight unit to turn on after the Nth image data region of the right eye image or the left eye image is refreshed, and
the control unit controls the backlight unit to turn off when a next left eye image or right eye image is started to be refreshed.

20. The driving method of the three-dimensional display as claimed in claim 14, wherein
the control unit controls the backlight unit to turn on after the Nth image data region of the right eye image or the left eye image is refreshed, and
the control unit controls the backlight unit to turn off when the phase modulator unit is fully switched to be the right eye phase or the left eye phase.

21. The driving method of the three-dimensional display as claimed in claim 13, wherein a period between the image synchronizing control signal and a next image synchronizing control signal comprises a first time interval and a second time interval,
the display panel unit fully displays the right eye image or the left eye image in the first time interval, and the display panel unit refreshes a next left eye image or a next right eye image in the second time interval, and
the control unit controls the backlight unit is in a turn-on state in the first time interval and controls the backlight unit in a turn-off state in the second time interval.

22. The driving method of the three-dimensional display as claimed in claim 13, wherein
the right eye image of the display panel unit further comprises a right eye first color image, a right eye second color image and a right eye third color image, and the right eye first color image, the right eye second color image and the right eye third color image are sequentially displayed,
the left eye image of the display panel unit further comprises a left eye first color image, a left eye second color image and a left eye third color image, and the left eye first color image, the left eye second color image and the left eye third color image are sequentially displayed,
the backlight unit comprises a first color light source, a second color light source and a third color light source, wherein the control unit controls the backlight unit to turn on the first color light source, the second color light source and the third color light source according to the displaying of the right eye first color image, the right eye second color image and the right eye third color image, and
the control unit controls the backlight unit to turn on the first color light source, the second color light source and the third color light source according to the displaying of the left eye first color image, the left eye second color image and the left eye third color image.

23. The driving method of the three-dimensional display as claimed in claim 22, wherein
the right eye phase of the phase modulator unit comprises a first right eye phase, a second right eye phase and a third right eye phase, and the left eye phase of the phase modulator unit comprises a first left eye phase, a second left eye phase and a third left eye phase,
wherein the control unit controls the phase modulator unit to switch to be the first right eye phase, the second right eye phase and the third right eye phase according to the displaying of the right eye first color image, the right eye second color image and the right eye third color image, and
the control unit controls the phase modulator unit to switch to be the first left eye phase, the second left eye phase and the third left eye phase according to display of the left eye first color image, the left eye second color image and the left eye third color image.
